(19) United States
(12) Patent Application Publication
(10) Pub. No.: US 2020/0194132 A1
(43) Pub. Date: Jun. 18, 2020

(54) Fuel Loading Method and Reactor Core

(71) Applicant: Hitachi-GE Nuclear Energy, Ltd., Hitachi-shi (JP)

(72) Inventor: Takeshi MITSUYASU, Tokyo (JP)

(21) Appl. No.: 16/691,038

(22) Filed: Nov. 21, 2019

(30) Foreign Application Priority Data
Dec. 17, 2018 (JP) 2018-235371

(51) Int. Cl. G21C 3/326; G21C 1/08

(52) U.S. Cl. CPC G21C 3/326; G21C 1/084

(57) ABSTRACT

When all fuel assemblies loaded in a region excluding an outermost periphery of the reactor core in an Nth operation cycle belong to the first fuel assembly, and all fuel assemblies loaded in the region excluding the outermost periphery of the reactor core in a (N+m) th (m>1) operation cycle belong to the second fuel assembly, the number of new loaded second fuel assemblies in the (N+m) th operation cycle is greater than the number of new loaded second fuel assemblies in a (N+m−1) th operation cycle which is one operation cycle before the (N+m) th operation cycle, and a cycle burnup in the (N+m) th operation cycle is greater than a cycle burnup in the (N+m−1) th operation cycle.

### CLAIM OF PRIORITY

The present application claims priority from Japanese Patent application serial no. 2018-235371, filed on Dec. 17, 2018, the content of which is hereby incorporated by reference into this application.

### TECHNICAL FIELD

The present invention relates to a fuel loading method for a reactor and a reactor core using the same, and particularly relates to a technique that is effectively applied to a fuel loading method when transitioning to fuel in which an average uranium enrichment or an average fissile plutonium enrichment and a fuel rod arrangement are different.

### BACKGROUND ART

A plurality of fuel assemblies are loaded into a reactor core of a reactor. The fuel assembly includes a plurality of fuel rods in which a plurality of fuel pellets containing nuclear fuel materials (for example, uranium oxide: UO₂) are encapsulated, an upper tie plate that supports an upper end portion of the fuel rod, a lower tie plate that supports a lower end portion of the fuel rod, a plurality of fuel spacers that hold a space between the fuel rods, and a rectangular tubular channel box. The channel box has an upper end portion attached to the upper tie plate, extends toward the lower tie plate, and surrounds the plurality of fuel rods bundled by the plurality of fuel spacers.

A plurality of control rods are inserted into the reactor core so as to control reactor power. A part of the fuel rods in the fuel assembly contains a burnable poison (for example, gadolinia: Gd₂O₃) in the fuel pellet. The control rod and the burnable poison absorb excess neutrons generated by nuclear fission of the nuclear fuel material. The burnable poison turns into a substance that is difficult to absorb neutrons due to neutron absorption. Therefore, the burnable poison contained in a new fuel assembly (fuel assembly having a burnup of 0 GWd/t) loaded into the reactor core disappears when a certain operation period of the reactor has elapsed after the new fuel assembly is loaded into the reactor core.

The reactivity of the fuel assembly from which the burnable poison disappears monotonously decreases as the nuclear fuel material burns. Since a plurality of fuel assemblies with different number of operation cycles staying in the reactor core are loaded into the reactor core, the overall reactor core is maintained in a critical state throughout the operation period of the reactor. A new fuel assembly (first cycle fuel) loaded into the reactor core is burned in a constant operation period, and then loaded at a different position in the reactor core during periodic inspection. At this time, the fuel is a fuel burned for one cycle, and is referred to as a second cycle fuel. When the cycle is repeated several times, the fuel is removed from the reactor core. New fuel having the number same as the number of fuel assemblies removed from the reactor core is loaded into the reactor core.

In many cases, as for the fuel to be loaded into the reactor core, a specific type of fuel is loaded, but a new fuel assembly having a type different from before may be loaded according to the performance of the fuel. As described above, since the fuel stays in the reactor core for several cycles, an old fuel assembly remains in the reactor core even when a new fuel assembly is loaded. Such a reactor core is referred to as a “transition reactor core”. When the transition reactor core is operated for several cycles, the fuel assemblies in the reactor core are all new fuel assemblies, and a variation in reactor core characteristics for each cycle is reduced after several cycles. The reactor core is referred to as an “equilibrium reactor core”. Since the new fuel assembly and the old fuel assembly are present in the transition reactor core, various devises are made so as to make an operating margin of the reactor core the same as that of the equilibrium reactor core.

Therefore, for example, a technique as disclosed in PTL 1 has been proposed. In a boiling water reactor, when pressure loss characteristics of fuel assemblies are different, a flow rate of a coolant flowing through each fuel assembly is changed so as to keep the pressure loss of each fuel assembly constant. In PTL 1, when transitioning from fuel in an 8×8 array to new fuel in a 9×9 array, the pressure loss characteristics are made equal by loading the 9×9 fuel with the pressure loss characteristic matched to the 8×8 fuel.

In this state, when transition from the 8×8 fuel to the 9×9 fuel is performed, and the amount of the 9×9 fuel is greater to some extent, the original 9×9 fuel is loaded. Since the 9×9 fuel has a thermal margin larger than that of the 8×8 fuel, there is no problem in operating the reactor core even when the pressure loss characteristics are different.

### PRIOR ART LITERATURE

### Patent Literature

PTL 1: JP-A-1-201189

### SUMMARY OF INVENTION

### Technical Problem

Incidentally, a fuel assembly loaded into a reactor core is used in a range that is previously authorized. It is conceivable that the authorized range is wide for a high-performance new fuel assembly. For example, a new fuel assembly has a larger limit of a maximum burnup of the fuel assembly.

In the transition reactor core, the old fuel assembly needs to follow an authorized range of the old fuel assembly, and the new fuel assembly needs to follow an authorized range of the new fuel assembly. If the fuel economical efficiency of the new fuel assembly is improved with respect to the old fuel assembly, the number of fuel assemblies newly loaded into the reactor core is smaller for the new fuel assembly than the old fuel assembly.

Since the number of fuel assemblies newly loaded into the reactor core and the number of fuel assemblies removed therefrom are the same, the number of the old fuel assemblies removed decreases. As a result, since the old fuel assembly to be removed stays in the reactor core, a burnup of the old fuel assembly increases. When the operation is repeated several cycles, there is a possibility of exceeding the authorized range of the old fuel assembly, so that a reactor core operation using the old fuel assembly may not be performed.

In order to make the burnup of the older fuel assembly the same as that in the related art, the number of the new fuel assembly for replacement may be made the same as the old fuel assembly in the related art. At this time, it is not possible to enjoy a merit of reducing the number for replacement by using the new fuel assembly. Thus, there is a problem in transitioning to improve the economical efficiency within the authorization limit.

PTL 1 proposes a method of preparing a new fuel assembly having pressure loss characteristics identical to those of the old fuel assembly, focusing on the thermal margin. In this case, a new fuel assembly is required, and an authorization thereof is required, but the economical efficiency during the transition as described above is not mentioned.

Therefore, an object of the invention is to provide a fuel loading method and a reactor core using the same capable of, in a transition reactor core when transitioning from an old fuel assembly to a new fuel assembly in which at least one of an average uranium enrichment, an average fissile plutonium enrichment, and a fuel rod arrangement is different from the old fuel assembly, improving the economical efficiency of the transition reactor core within an authorization limit range of the old fuel assembly.

### Solution to Problem

In order to solve the above problems, the invention provides a fuel loading method for a transition reactor core when transitioning from a first fuel assembly to a second fuel assembly in which at least one of an average uranium enrichment, an average fissile plutonium enrichment, and a fuel rod arrangement is different from that of the first fuel assembly, in which, when all fuel assemblies loaded in a region excluding an outermost periphery of the reactor core in an Nth operation cycle belong to the first fuel assembly, and all fuel assemblies loaded in the region excluding the outermost periphery of the reactor core in a (N+m)th (m>1) operation cycle belong to the second fuel assembly, the number of new loaded second fuel assemblies in the (N+m)th operation cycle is greater than the number of new loaded second fuel assemblies in a (N+m−1)th operation cycle which is one operation cycle before the (N+m)th operation cycle, and a cycle burnup in the (N+m)th operation cycle is greater than a cycle burnup in the (N+m−1)th operation cycle.

In addition, the invention provides a reactor core when transitioning from a first fuel assembly to a second fuel assembly in which at least one of an average uranium enrichment, an average fissile plutonium enrichment, and a fuel rod arrangement is different from that of the first fuel assembly, in which, when all fuel assemblies loaded in a region excluding an outermost periphery of the reactor core in an Nth operation cycle belong to the first fuel assembly, and all the fuel assemblies loaded in the region excluding the outermost periphery of the reactor core in a (N+m)th (m>1) operation cycle belong to the second fuel assembly, the number of new loaded second fuel assemblies in the (N+m)th operation cycle is greater than the number of new loaded second fuel assemblies in a (N+m−1)th operation cycle which is one operation cycle before the (N+m)th operation cycle, and a cycle burnup in the (N+m)th operation cycle is greater than a cycle burnup in the (N+m−1)th operation cycle.

### Advantageous Effect

According to the invention, the fuel loading method and the reactor core using the same capable of, in a transition reactor core when transitioning from an old fuel assembly to a new fuel assembly in which at least one of an average uranium enrichment, an average fissile plutonium enrichment, and a fuel rod arrangement is different from that of the old fuel assembly, improving the economical efficiency of the transition reactor core within an authorization limit range of the old fuel assembly can be realized.

Problems, configurations, and effects other than the above will become apparent from description of embodiments below.

### BRIEF DESCRIPTION OF DRAWINGS

FIG. 1 is a diagram conceptually showing a fuel loading (replacing) method according to a first embodiment of the invention.

FIG. 2 is a diagram showing a fuel loading (replacing) method of a comparative example (case 1).

FIG. 3 is a diagram showing a time transition of a maximum burnup.

FIG. 4 is a diagram showing a fuel loading (replacing) method of a comparative example (case 2).

FIG. 5 is a diagram showing a relative comparison of power generation costs.

FIG. 6 is an overall schematic configuration diagram of a fuel assembly according to a second embodiment of the invention.

FIG. 7 is a cross-sectional view (horizontal cross-sectional view) taken along a line A-A in FIG. 6 (9×9 array).

FIG. 8 is a schematic configuration diagram of an advanced boiling water reactor according to the second embodiment of the invention.

FIG. 9 is a fuel loading pattern diagram according to the second embodiment of the invention (Nth cycle).

FIG. 10 is a horizontal cross-sectional view of the fuel assembly according to the second embodiment of the invention (10×10 array).

FIG. 11 is a fuel loading pattern diagram according to the second embodiment of the invention ((N+1)th cycle).

FIG. 12 is a fuel loading pattern diagram according to the second embodiment of the invention ((N+2)th cycle).

FIG. 13 is a fuel loading pattern diagram according to the second embodiment of the invention ((N+3)th cycle).

FIG. 14 is a horizontal cross-sectional view of a fuel assembly according to a third embodiment of the invention (11×11 array).

FIG. 15 is a fuel loading pattern diagram according to a fourth embodiment of the invention ((N+3)th cycle).

FIG. 16 is a fuel loading pattern diagram according to the fourth embodiment of the invention ((N+4)th cycle).

### DESCRIPTION OF EMBODIMENTS

Hereinafter, embodiments of the invention will be described with reference to the drawings. In the drawings, the same components are denoted by the same reference numerals, and a detailed description of the repeated parts will be omitted.

The present inventors have conducted various studies and find a new method of increasing economical efficiency of a transition reactor core within an authorization limit range. Results of the study and a newly found fuel loading method will be described below.

### First Embodiment

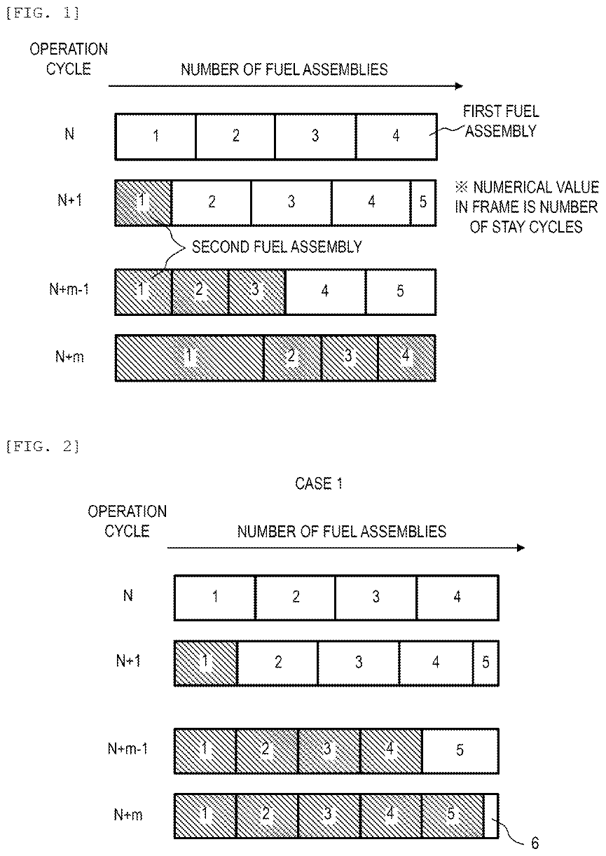

A fuel loading (replacing) method according to a first embodiment of the invention will be described with reference to FIGS. 1 to 5.

It is assumed that in a transition reactor core, a new fuel assembly newly loaded has a uranium or plutonium fuel loading amount (inventory) per fuel assembly larger than that of the old fuel assembly. In this case, the new fuel assembly is more economical than the old fuel assembly. Further, even when a fuel loading amount of the new fuel assembly is equal to or less than that of the old fuel assembly, an infinite multiplication factor of the new fuel assembly may be higher than that of the old fuel assembly. For example, the new fuel assembly may have an average uranium enrichment higher than that of the old fuel assembly. If the new fuel assembly is larger in the fuel loading amount than the old fuel assembly, and the infinite multiplication factors at the same burnup are the same, the replacement number of fuel assemblies in the reactor core is reduced by an increase in the fuel loading amount as compared to the old fuel assembly.

In general, since a fuel assembly cost is not only a raw material expense or a uranium enrichment expense, an increase in the fuel assembly cost is less than an increase in the fuel loading amount. Therefore, the fuel economical efficiency is improved when the number of the new fuel assembly loaded is reduced. When the number of the new fuel assembly loaded is reduced, the number of the fuel assembly for replacement is also reduced. That is, by reducing the number of fuel assemblies to be removed in the old fuel assembly, an in-reactor stay period of the remaining old fuel assembly is extended. Even when the in-reactor stay period is extended, an increase in a burnup can be prevented by loading on an outer peripheral portion of the reactor core where the fuel assemblies slightly burn due to lower assembly power. In the reactor core in which the new fuel assemblies are loaded for several cycles and the old fuel assemblies remain, the old fuel assemblies in which the in-reactor stay period is extended increase.

As a result, the number of the fuel assemblies that can be loaded into the outer peripheral portion of the reactor core exceeds the number of the old fuel assemblies in which the in-reactor stay period is extended, and a maximum burnup of the old fuel assembly increases. In general, the maximum burnup is defined as one of authorization conditions for the fuel assembly, and a discharged burnup with a margin for the maximum burnup is set in the reactor core design.

However, when a difference in the economical efficiency between the old fuel assembly and the new fuel assembly is large (for example, when a difference in fuel loading amount is large), a margin for the maximum burnup is reduced since the number of older fuel assemblies in which the in-reactor stay period is extended increases. When the margin for the burnup decreases or disappears, an operation of the transition reactor core may not be continued.

Further, when the operation of the transition reactor core is stopped, all the old fuel assemblies reaching the maximum burnup are removed, and when the new fuel assemblies are loaded, the fuel cost increases. Since the new fuel assembly generates energy in the reactor core after several cycles, a recovery of the fuel cost requires several cycles.

Therefore, the present inventors have devised a method of loading a new fuel assembly while preventing such an increase in cost. When the new fuel assembly is loaded into the transition reactor core, the maximum burnup of the old fuel assembly increases after several cycles. In a case where the next cycle is the same fuel replacing procedure, the old fuel assembly is replaced with the new fuel assembly when the maximum burnup of the old fuel assembly is expected to exceed the limit range.

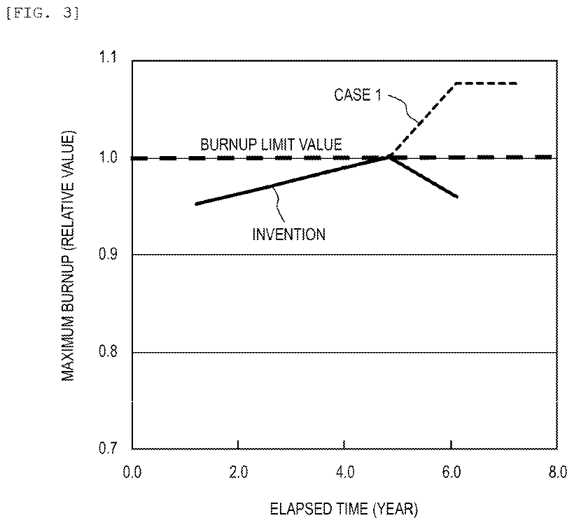

FIG. 1 shows a fuel loading (replacing) method according to the present embodiment (the invention). A horizontal axis indicates the number of fuel assemblies, a longitudinal axis indicates an operation cycle, and numerals in the figure indicate the number of in-reactor stay cycle. As a comparative example, FIG. 2 shows a case where only a necessary amount of the new fuel assembly as described above is loaded (case 1). Further, FIG. 3 shows a time transition of the maximum burnup of the old fuel assembly in these transition reactor cores. From FIG. 3, it can be seen that the fuel loading (replacing) method according to the present embodiment (the invention) can use the maximum burnup of the old fuel assembly within the authorization limit range.

Next, the present inventors have devised a cost recovery method for a large number of newly loaded fuel assemblies. As described above, even when a large number of new fuel assemblies are loaded, the fuel cost is recovered after several cycles, but it takes time until the cost is recovered. In order to early recover a cost increase due to such an increase in the number of fuel assemblies for replacement, in a cycle in which the fuel loading method for avoiding a limit of the maximum burnup of the old fuel assembly is performed by loading a large number of new fuel assemblies, it is considered to perform a long-term cycle operation or an power uprate operation by making good use of the fact that the number of loaded fuel assemblies for the new fuel assembly is large.

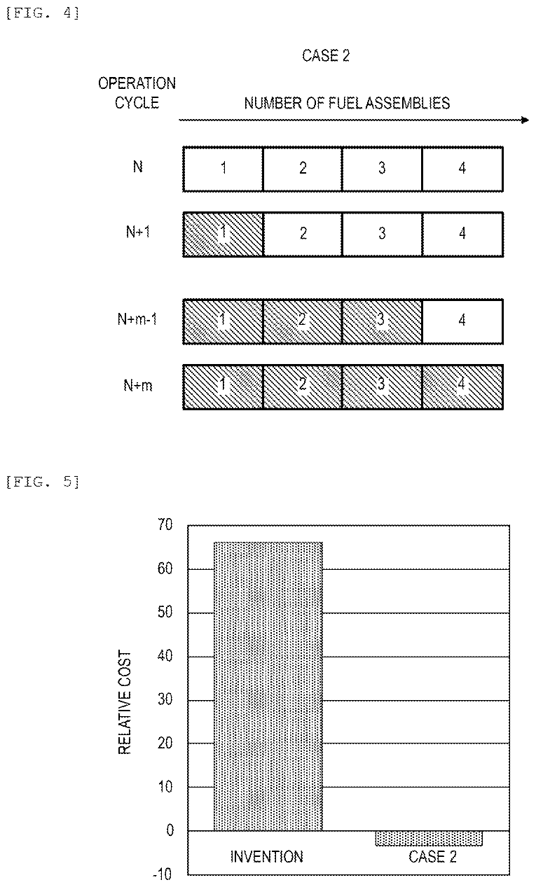

In these operations, a cycle burnup is larger compared to previous cycles. In the long-term cycle operation or the power uprate operation, since the energy generation amount of the cycle increases, the cost can be easily recovered. As another comparative example, FIG. 4 shows a case where the number of new fuel assemblies is used in the number same as the number of the old fuel assemblies to be replaced in a transition reactor core in which new fuel assemblies are loaded (case 2). FIG. 5 shows an example of a power generation cost comparison from an introduction of the new fuel assembly to a transition completion (N+m+1) cycle for the invention (FIG. 1) and the case 2 (FIG. 4). The power generation cost of each case is indicated by an increase or a decrease (relative cost) with respect to a case where an operation is continued with the old fuel assembly. In the case 2 (FIG. 4), the numbers for replacement of the old fuel assembly and of the new fuel assembly are the same until the transition, but the fuel economical efficiency is negative and the power generation cost is negative since unit the price of fuel assemblies is higher for the new fuel assemblies due to the increased inventory.

Thus, in order to improve the economical efficiency within an authorization range of the maximum burnup of the old fuel assembly in the transition reaction core in which a transition to the new fuel assembly is performed, the long-term cycle operation or the power uprate operation is devised in a cycle where the transition is completed. Although almost all of the fuel assemblies are the new fuel assemblies in the reactor core where the transition is completed, the old fuel assembly may be loaded in an outermost peripheral region of the reactor core which is not easily affected by a long-term operation cycle (cycle burnup extension) or power uprate (fuel assembly power increase).

The fuel loading (replacing) method according to the present embodiment is a fuel loading method for a transition reactor core when transitioning from an old fuel assembly (first fuel assembly) to a new fuel assembly (second fuel assembly) in which at least one of an average uranium enrichment, an average fissile plutonium enrichment, and a fuel rod arrangement is different from that of the old fuel assembly, in which, when all fuel assemblies loaded in a region excluding an outermost periphery of the reactor core in an Nth operation cycle belong to the old fuel assembly (first fuel assembly), and all the fuel assemblies loaded in the region excluding the outermost periphery of the reactor core in a (N+m) th (m>1) operation cycle belong to the new fuel assembly (second fuel assembly), the number of new loaded new fuel assemblies (second fuel assemblies) in the (N+m)th operation cycle is greater than the number of new loaded new fuel assemblies (second fuel assemblies) in a (N+m−1) th operation cycle which is one operation cycle before the (N+m) th operation cycle, and a cycle burnup in the (N+m) th operation cycle is greater than a cycle burnup in the (N+m−1) th operation cycle.

The average uranium enrichment of the new fuel assemblies (second fuel assemblies) is also higher than the average uranium enrichment of the old fuel assemblies (first fuel assemblies). Alternatively, the average fissile plutonium enrichment of the new fuel assemblies (second fuel assemblies) is higher than the average fissile plutonium enrichment of the old fuel assemblies (first fuel assemblies).

A specific fuel loading example according to the invention reflecting the above study results will be described in second and subsequent embodiments with reference to the drawings.

Hereinafter, an advanced boiling water reactor (ABWR) will be described as an example of an application target of the invention, but the invention is not limited thereto. For example, the fuel loading method can be similarly applied to other reactors such as a normal boiling water reactor (BWR) that includes a recirculation pump and circulates a coolant (which also functions as a neutron moderator) by flowing the coolant out of a reactor pressure vessel and flowing the coolant back into a downcomer inside the reactor pressure vessel or an economic simplified boiling water reactor (ESBWR) that eliminates a need for the recirculation pump in the BWR and an internal pump in the ABWR by using a natural circulation method of cooling water by chimney.

### Second Embodiment

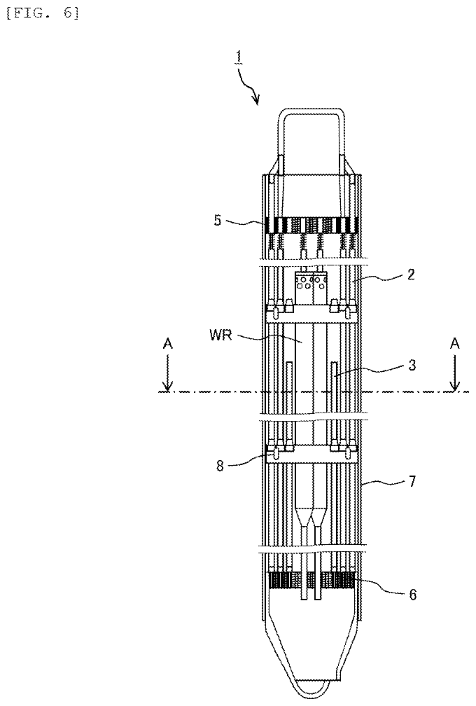

A fuel loading (replacing) method according to a second embodiment of the invention and a reactor core using the same will be described with reference to FIGS. 6 to 13.

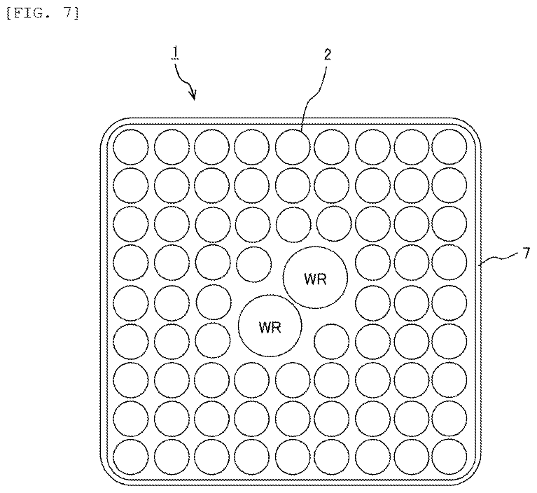

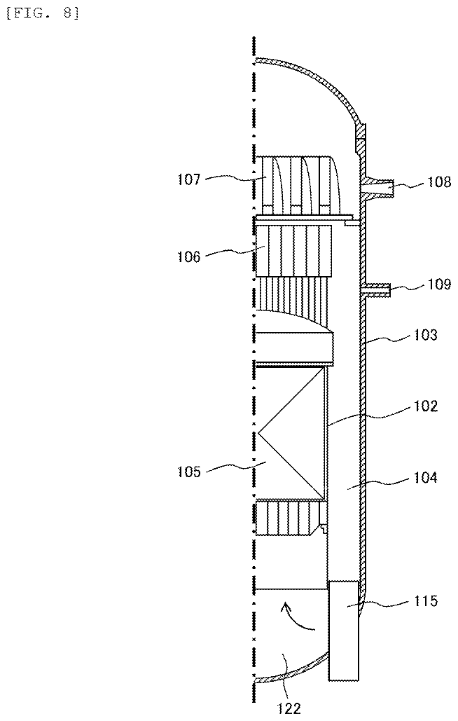

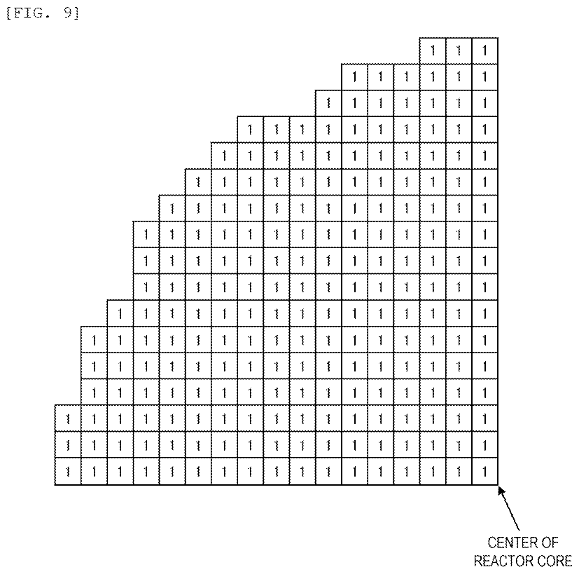

FIG. 6 is an overall schematic configuration diagram of a fuel assembly according to the present embodiment. FIG. 7 is a cross-sectional view (horizontal cross-sectional view) taken along a line A-A in FIG. 6 and shows an example of a 9×9 array. FIG. 8 is a schematic configuration diagram of an advanced boiling water reactor including a reactor core loaded with the fuel assembly shown in FIG. 7.

As shown in FIG. 8, in the advanced boiling water reactor (ABWR), a cylindrical reactor core shroud 102 is provided in a reactor pressure vessel (reactor vessel) 103, and a reactor core 105 loaded with a plurality of fuel assemblies (not shown) is disposed in the reactor core shroud 102.

In addition, a steam and water separator 106 extending above the reactor core 105 and a steam dryer 107 disposed above the steam and water separator 106 are provided in the reactor pressure vessel (hereinafter also referred to as RPV) 103. An annular downcomer 104 is formed between the RPV 103 and the reactor core shroud 102. An internal pump 115 is disposed in the downcomer 104.

Cooling water discharged from the internal pump 115 is supplied to the reactor core 105 via a lower plenum 122. The cooling water is heated when passing through the reactor core 105 to form a gas-liquid two-phase flow containing water and steam. The steam and water separator 106 separates the gas-liquid two-phase flow into steam and water. The separated steam is further dehumidified by the steam dryer 107 and guided to a main steam pipe 108.

The dehumidified steam is guided to a steam turbine (not shown) to rotate the steam turbine. A generator connected to the steam turbine rotates to generate power. The steam discharged from the steam turbine is condensed into water by a condenser (not shown). The condensed water is supplied as cooling water into the RPV 103 by a water supply pipe 109. The water separated by the steam-water separator 106 and the steam dryer 107 falls down and reaches the downcomer 104 as cooling water.

Although not shown in FIG. 8, a control rod guide pipe that allows a plurality of control rods CR having a cruciform cross section to be inserted into the reactor core 105 so as to control a nuclear reaction of the fuel assembly is provided in the lower plenum. 122 of the RPV 103, a control rod drive mechanism is provided in a control rod drive mechanism housing installed below a bottom of the RPV 103, and the control rod is connected to the control rod drive mechanism.

FIG. 6 shows an overall schematic configuration diagram of a fuel assembly 1. The fuel assembly 1 according to the present embodiment includes a plurality of fuel rods 2, a partial length fuel rod 3, an upper tie plate 5, a lower tie plate 6, a plurality of fuel spacers 8, a plurality of water rods WR, and a channel box 7. The fuel rods 2 (so-called full length fuel rods) and the partial length fuel rods 3 are filled with a plurality of fuel pellets (not shown) sealed in a fuel cladding tube (not shown).

The lower tie plate 6 supports lower end portions of the fuel rods 2 and the partial length fuel rods 3, and the upper tie plate 5 holds upper end portions of the fuel rods 2. Lower end portions of the water rods WR are supported by the lower tie plate 6, and upper end portions of the water rods WR are held by the upper tie plate 5. The plurality of fuel spacers 8 are arranged at predetermined intervals in an axial direction of the fuel assembly 1, and hold the fuel rods 2 and the water rods WR so as to form a flow path through which cooling water flows between the fuel rods 2 (including the partial length fuel rod 3) and between the fuel rod 2 and the water rod WR.

The channel box 7, which is a square tube having a square cross section, is attached to the upper tie plate 5 and extends downward. The fuel rods 2 bundled by the fuel spacers 8 are disposed in the channel box 7. A handle is fastened to an upper end portion of the upper tie plate 5, and when the handle is lifted, the overall fuel assembly 1 can be pulled up.

FIG. 7 is a cross-sectional view (horizontal cross-sectional view) of the fuel assembly 1 viewed from the line A-A as shown in FIG. 6. As shown in FIG. 7, in the horizontal cross section of the fuel assembly 1, the fuel rods 2 and the water rods WR are arranged in a square grid of 9 rows and 9 columns (9×9 array) formed in the channel box 7. Two water rods WR having a cross-sectional area that occupies a region where approximately four fuel rods 2 can be arranged are arranged at a central portion of the horizontal cross section (cross section) of the fuel assembly 1. The water rod WR is a large diameter water rod. In the present embodiment, a length of a region of the fuel rod 2 where a fuel pellet containing fissile uranium is loaded, that is, an effective length of the fuel shown in FIG. 6, is 3.7 m.

When the fuel assembly 1 is loaded into the reactor core 105 of the advanced boiling water reactor (ABWR), one corner is disposed to face a control rod CR (not shown) with a cruciform cross section inserted into the reactor core 105. The channel box 7 is attached to the upper tie plate 5 by a channel fastener (not shown). The channel fastener has a function of holding a gap having a necessary width between the fuel assemblies 1 such that the control rod CR (not shown) can be inserted between the fuel assemblies 1 when the fuel assembly 1 is loaded into the reactor core 105. Therefore, the channel fastener (not shown) is attached to the upper tie plate 5 so as to be located at the corner facing the control rod CR (not shown).

In other words, a corner portion facing the control rod CR (not shown) of the fuel assembly 1 is a corner portion to which the channel fastener (not shown) is attached. Each fuel pellet filled in each fuel rod 2 is manufactured by using uranium dioxide (UO₂) and plutonium. oxide (PuO₂) which are nuclear fuel materials, and contains uranium-235, plutonium-239, plutonium-241, and the like which are fissile materials.

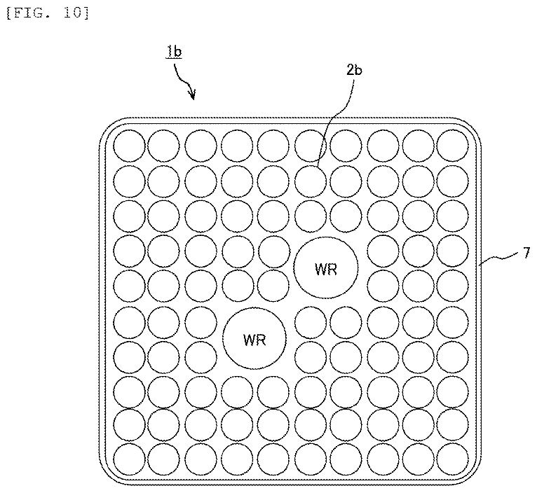

FIG. 9 is a fuel loading pattern of ¼ of the reactor core in an Nth cycle. A lower right part of the figure is a center of the reactor core and the fuel loading pattern is rotationally symmetric. Numeral in a fuel assembly position indicates a type of the fuel. Numeral of the fuel assembly shown in FIG. 7 is set to 1, and only this fuel assembly is loaded.

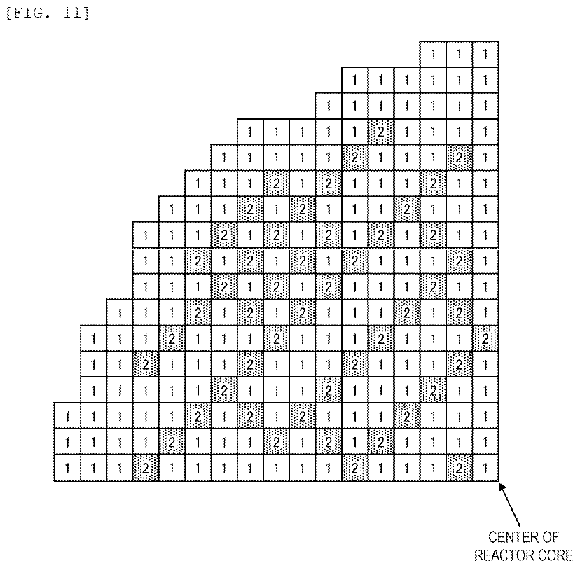

FIG. 10 shows a horizontal cross-sectional view of a new fuel assembly in a 10×10 array when the fuel in FIG. 7 is taken as an old fuel assembly in a 9×9 array. As shown in FIG. 10, in a horizontal cross section of a fuel assembly 1b, fuel rods 2b and water rods WR are arranged in a square grid of 10 rows and 10 columns (10×10 array) formed in the channel box 7. Two water rods WR having a cross-sectional area that occupies a region where approximately four fuel rods 2b can be arranged are arranged at a central portion of the horizontal cross section (cross section) of the fuel assembly 1b. The water rod WR is a large diameter water rod. A length of a region of the fuel rod 2b where a fuel pellet containing fissile uranium is loaded, that is, an effective length of the fuel, is 3.8 m.

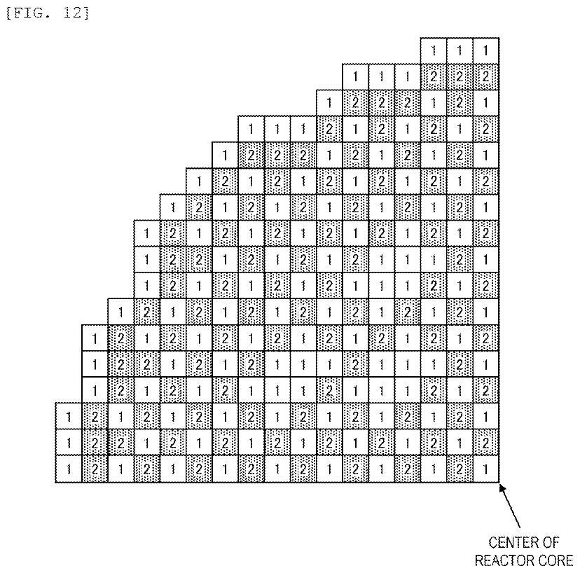

FIG. 11 shows a fuel loading pattern of ¼ of the reactor core in a (N+1)th cycle in which the fuel shown in FIG. 10 is loaded. The new fuel assembly shown in FIG. 10 is indicated as numeral 2 in the fuel assembly position. The number of loaded new fuel assemblies is 50 in ¼ of the reactor core.

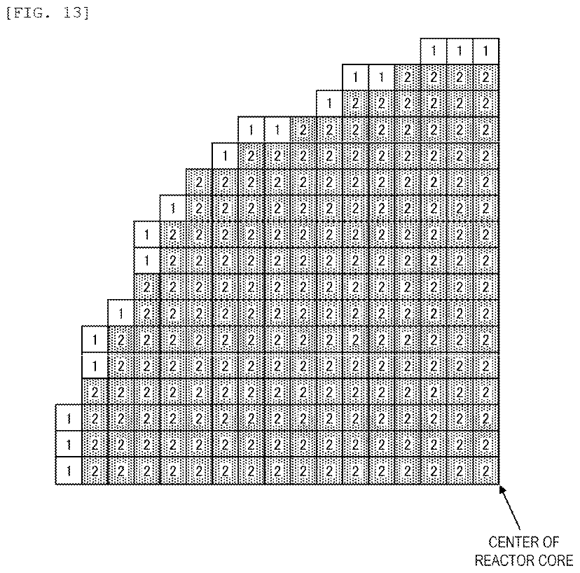

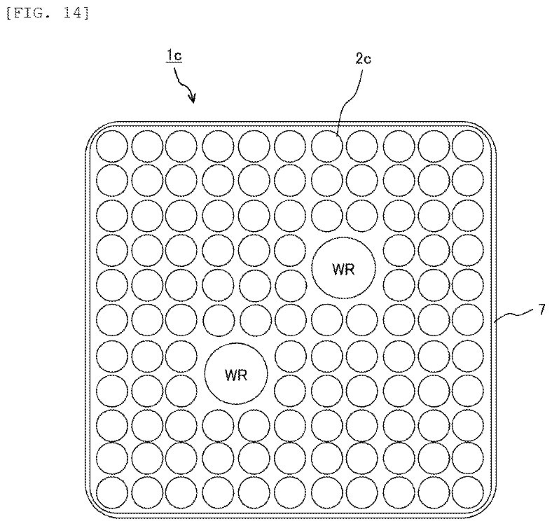

FIG. 12 shows a case where 50 new fuel assemblies are loaded in a (N+2)th cycle which is a next cycle. FIG. 13 shows a fuel loading pattern in a (N+3)th cycle when 100 new fuel assemblies are loaded into ¼ of the reactor core after the (N+2)th cycle is ended.

In the fuel loading (replacing) method according to the present embodiment, the old fuel assembly (first fuel assembly) is a square grid fuel rod array of 9 rows and 9 columns, and the new fuel assembly (second fuel assembly) is a square grid fuel rod array of 10 rows and 10 columns.

The new fuel assembly is loaded into the reactor core excluding a loading position on the outermost periphery thereof, and even when the long-term cycle operation or the power uprate operation is performed in the state, the thermal margin of the old fuel assembly is not impaired. The maximum burnup of the old fuel assembly at this time is as shown in FIG. 3. Further, the power generation cost is as shown in FIG. 5.

As described above, according to the present embodiment, it is possible to increase the economical efficiency of the overall reactor core while using the old fuel assembly within the authorization limit range.

### Third Embodiment

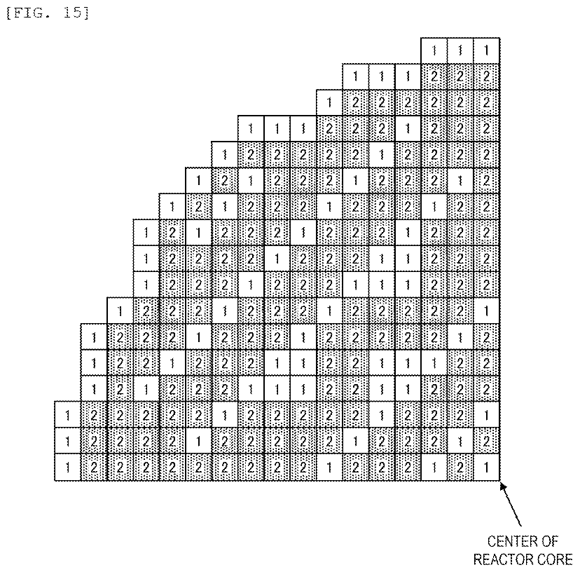

A fuel loading (replacing) method according to a third embodiment of the invention will be described with reference to FIG. 14.

FIG. 14 is a horizontal cross-sectional view of a new fuel assembly according to the present embodiment. The present embodiment is different from the second embodiment in that the new fuel assembly is a square grid of 11 rows and 11 columns (11×11 array) shown in FIG. 14 when the old fuel assembly is a square grid of 10 rows and 10 columns (10×10 array) shown in FIG. 10. The other points are the same as in the second embodiment, and the description repetitive with the second embodiment is omitted below.

As shown in FIG. 14, in the new fuel assembly according to the present embodiment, in a horizontal cross section of a fuel assembly 1c, fuel rods 2c and water rods WR are arranged in a square grid of 11 rows and 11 columns (11×11 array) formed in the channel box 7. Two water rods WR having a cross-sectional area that occupies a region where four fuel rods can be arranged are arranged at a central portion of the horizontal cross section (cross section) of the fuel assembly 1c. A length of a region where a fuel pellet containing fissile uranium is loaded into the fuel rod 2c, that is, an effective length of the fuel according to the present embodiment, is 3.8 m.

In the fuel loading (replacing) method according to the present embodiment, the old fuel assembly (first fuel assembly) is a square grid fuel rod array of 10 rows and 10 columns, and the new fuel assembly (second fuel assembly) is a square grid fuel rod array of 11 rows and 11 columns.

As described above, according to the present embodiment, in addition to the effects of the second embodiment, by transitioning to a fuel assembly having a square grid of 11 rows and 11 columns (11×11 array), the thermal margin is increased and the economical efficiency is improved.

### Fourth Embodiment

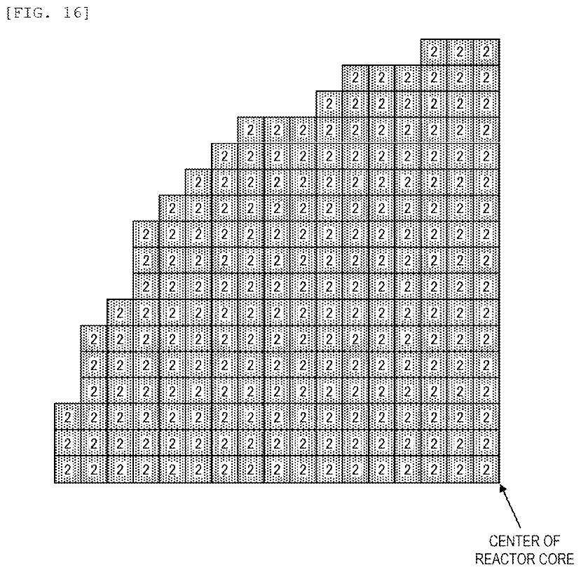

A fuel loading (replacing) method according to a fourth embodiment of the invention will be described with reference to FIGS. 15 and 16.

In the present embodiment, a fuel loading pattern when a large number of new fuel assemblies are loaded is different from that of the second embodiment. The other points are the same as in the second embodiment, and the description repetitive with the second embodiment is omitted below.

In the present embodiment, a fuel loading pattern in an Nth cycle is the same as that of the second embodiment (FIG. 9), and a fuel loading pattern in a (N+1)th cycle is the same as that of the second embodiment (FIG. 11). Here, in a (N+3)th cycle, similarly to the (N+2)th cycle in the second embodiment (FIG. 12), 50 new fuel assemblies are loaded into ¼ of the reactor core. A fuel loading pattern in the (N+3)th cycle is shown in FIG. 15. A fuel loading pattern in a (N+4)th cycle is shown in FIG. 16.

In the (N+4)th cycle, the reactor core is loaded with all new fuel assemblies by loading 68 new fuel assemblies.

In the fuel loading (replacing) method according to the present embodiment, all the fuel assemblies in the reactor core in an Nth operation cycle are old fuel assemblies (first fuel assemblies), and all the fuel assemblies in the reactor core in a (N+m)th operation cycle are new fuel assemblies (second fuel assemblies).

According to the present embodiment, in addition to the effects of the second embodiment, an power distribution can be flattened, and the thermal margin of the reactor core can be improved as compared with the second embodiment since the thermal margin on the outermost periphery of the reactor core is also improved during the power uprate operation.

The invention is not limited to the embodiments described above, and includes various modifications. For example, the above embodiments are described in detail for easy understanding of the invention, and the invention is not necessarily limited to those including all the configurations described above. A part of the configuration of one embodiment can be replaced with the configuration of another embodiment, and the configuration of another embodiment can be added to the configuration of one embodiment. In addition, a part of the configuration of each embodiment may be added, deleted, or replaced with another configuration.

### REFERENCE SIGN LIST

1, 1b, 1c . . . fuel assembly
2, 2b, 2c . . . fuel rod
3 . . . partial length fuel rod
5 . . . upper tie plate
6 . . . lower tie plate
7 . . . channel box
8 . . . (fuel) spacer
WR . . . water rod
102 . . . reactor core shroud
103 reactor pressure vessel (reactor vessel, RPV)
104 . . . downcomer
105 . . . reactor core
106 . . . steam and water separator
107 . . . steam dryer
108 . . . main steam pipe
109 . . . water supply pipe
115 . . . internal pump
122 . . . lower plenum

1. A fuel loading method for a transition reactor core when transitioning from a first fuel assembly to a second fuel assembly in which at least one of an average uranium enrichment, an average fissile plutonium enrichment, and a fuel rod arrangement is different from that of the first fuel assembly, wherein
when all fuel assemblies loaded in a region excluding an outermost periphery of the reactor core in an Nth operation cycle belong to the first fuel assembly, and all fuel assemblies loaded in the region excluding the outermost periphery of the reactor core in a (N+m)th (m>1) operation cycle belong to the second fuel assembly, the number of new loaded second fuel assemblies in the (N+m) th operation cycle is greater than the number of new loaded second fuel assemblies in a (N+m−1)th operation cycle which is one operation cycle before the (N+m)th operation cycle, and a cycle burnup in the (N+m)th operation cycle is greater than a cycle burnup in the (N+m−1)th operation cycle.

2. The fuel loading method according to claim 1, wherein
all the fuel assemblies in the reactor core in the Nth operation cycle belong to the first fuel assembly, and
all the fuel assemblies in the reactor core in the (N+m) th operation cycle belong to the second fuel assembly.

3. The fuel loading method according to claim 1, wherein
the first fuel assembly is a square grid fuel rod array of 9 rows and 9 columns, and
the second fuel assembly is a square grid fuel rod array of 10 rows and 10 columns.

4. The fuel loading method according to claim 2, wherein
the first fuel assembly is a square grid fuel rod array of 9 rows and 9 columns, and
the second fuel assembly is a square grid fuel rod array of 10 rows and 10 columns.

5. The fuel loading method according to claim 1, wherein
the first fuel assembly is a square grid fuel rod array of 10 rows and 10 columns, and
the second fuel assembly is a square grid fuel rod array of 11 rows and 11 columns.

6. The fuel loading method according to claim 2, wherein
the first fuel assembly is a square grid fuel rod array of 10 rows and 10 columns, and
the second fuel assembly is a square grid fuel rod array of 11 rows and 11 columns.

7. The fuel loading method according to claim 1, wherein
the average uranium enrichment of the second fuel assembly is higher than the average uranium enrichment of the first fuel assembly.

8. The fuel loading method according to claim 2, wherein
the average uranium enrichment of the second fuel assembly is higher than the average uranium enrichment of the first fuel assembly.

9. The fuel loading method according to claim 1, wherein
the average fissile plutonium enrichment of the second fuel assembly is higher than the average fissile plutonium enrichment of the first fuel assembly.

10. The fuel loading method according to claim 2, wherein
the average fissile plutonium enrichment of the second fuel assembly is higher than the average fissile plutonium enrichment of the first fuel assembly.

11. A reactor core when transitioning from a first fuel assembly to a second fuel assembly in which at least one of an average uranium enrichment, an average fissile plutonium enrichment, and a fuel rod arrangement is different from that of the first fuel assembly, wherein
when all fuel assemblies loaded in a region excluding an outermost periphery of the reactor core in an Nth operation cycle belong to the first fuel assembly, and all the fuel assemblies loaded in the region excluding the outermost periphery of the reactor core in a (N+m)th (m>1) operation cycle belong to the second fuel assembly, the number of new loaded second fuel assemblies in the (N+m) th operation cycle is greater than the number of new loaded second fuel assemblies in a (N+m−1)th operation cycle which is one operation cycle before the (N+m)th operation cycle, and a cycle burnup in the (N+m)th operation cycle is greater than a cycle burnup in the (N+m−1)th operation cycle.

12. The reactor core according to claim 11, wherein
all the fuel assemblies in the reactor core in the Nth operation cycle belong to the first fuel assembly, and
all the fuel assemblies in the reactor core in the (N+m) th operation cycle belong to the second fuel assembly.

13. The reactor core according to claim 11, wherein
the first fuel assembly is a square grid fuel rod array of 9 rows and 9 columns, and
the second fuel assembly is a square grid fuel rod array of 10 rows and 10 columns.

14. The reactor core according to claim 12, wherein
the first fuel assembly is a square grid fuel rod array of 9 rows and 9 columns, and
the second fuel assembly is a square grid fuel rod array of 10 rows and 10 columns.

15. The reactor core according to claim 11, wherein
the first fuel assembly is a square grid fuel rod array of 10 rows and 10 columns, and
the second fuel assembly is a square grid fuel rod array of 11 rows and 11 columns.

16. The reactor core according to claim 12, wherein
the first fuel assembly is a square grid fuel rod array of 10 rows and 10 columns, and
the second fuel assembly is a square grid fuel rod array of 11 rows and 11 columns.

17. The reactor core according to claim 11, wherein
the average uranium enrichment of the second fuel assembly is higher than the average uranium enrichment of the first fuel assembly.

18. The reactor core according to claim 12, wherein
the average uranium enrichment of the second fuel assembly is higher than the average uranium enrichment of the first fuel assembly.

19. The reactor core according to claim 11, wherein
the average fissile plutonium enrichment of the second fuel assembly is higher than the average fissile plutonium enrichment of the first fuel assembly.

20. The reactor core according to claim 12, wherein
the average fissile plutonium enrichment of the second fuel assembly is higher than the average fissile plutonium enrichment of the first fuel assembly.
